(19) United States
(12) Patent Application Publication
(10) Pub. No.: US 2016/0320507 A1
(43) Pub. Date: Nov. 3, 2016

(54) TIME LAPSE SEISMIC DATA PROCESSING

(71) Applicant: WesternGeco, LLC, Houston, TX (US)

(72) Inventors: Artem Kashubin, East Grinstead (GB); Daniele Boiero, Beckenham (GB)

(21) Appl. No.: 14/698,677

(22) Filed: Apr. 28, 2015

(51) Int. Cl. G01V 1/36; G01V 1/28

(52) U.S. Cl. CPC G01V 1/364; G01V 1/282; G01V 1/368

(57) ABSTRACT

Various implementations described herein are directed to methods for processing seismic data. The methods may include generating a computer-generated synthetic coherent noise model using a first seismic dataset that had been acquired with seismic sensors in a base seismic survey. The methods may include modifying a second seismic dataset that had been acquired in a repeat seismic survey using the computer-generated synthetic coherent noise model to generate a modified second seismic dataset having reduced coherent noise.

### BACKGROUND

Seismic exploration involves surveying subterranean geological formations for hydrocarbon deposits. A seismic survey may involve deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy one type of sensors or both. In response to the detected seismic events, the seismic sensors generate electrical signals to produce seismic data and related information. Analysis of the seismic data can then indicate the presence or absence of probable locations of hydrocarbon deposits.

Surface waves (also called ground-roll on land and mud-roll on sea bed) as well as guided waves are energetic parts of the seismic wavefield that are masking weaker reflections of desired signals. Surface waves can propagate without radiation into the Earth's interior, are parallel to Earth's surface, and have a reduced geometric spreading as compared to body waves. Surface waves can carry a part of energy that is radiated by a seismic source at Earth's surface.

Further, surface waves can constitute coherent noise in seismic data. In this manner, surface waves can be source-generated events characterized by relatively low velocity and relatively high amplitudes, and surface waves can superimpose onto a useful signal. This coherent noise may be in a form of many different wave types, such as Rayleigh waves with multiple modes of propagation, Lamb waves, P-guided waves, Love waves and Scholte waves.

The propagation properties of surface waves depend on the (visco) elastic properties of the near-surface, e.g., the shallow portion of Earth, which is responsible for much of the perturbation and degradation of the acquired seismic data. For purposes of designing filters to attenuate surface wave noise, it is generally useful to identify the properties of the surface waves. Additionally, knowledge of surface wave properties may be beneficial for other purposes, such as determining the local (visco) elastic properties of the near surface and estimating static corrections.

### SUMMARY

Described herein are implementations of various technologies of a method for processing seismic data. In one implementation, the method may include generating a computer-generated synthetic coherent noise model using a first seismic dataset that had been acquired with seismic sensors in a base seismic survey. The method may include modifying a second seismic dataset that had been acquired in a repeat seismic survey using the computer-generated synthetic coherent noise model to generate a modified second seismic dataset having reduced coherent noise.

Described herein are implementations of various technologies of a non-transitory computer-readable medium having stored thereon a plurality of computer-executable instructions which, when executed by a computer, cause the computer to process seismic data. In one implementation, the instructions may be configured to cause the computer to generate a computer-generated synthetic coherent noise model using a first seismic dataset that had been acquired with seismic sensors in a base seismic survey. The instructions may be configured to cause the computer to modify a second seismic dataset that had been acquired in a repeat seismic survey using the computer-generated synthetic coherent noise model to generate a modified second seismic dataset having reduced coherent noise.

Described herein are implementations of various technologies of an apparatus configured to process seismic data. In one implementation, the apparatus may include a processor and memory having instructions stored thereon that, when executed by the processor, cause the processor to process seismic data. In one implementation, the instructions may be configured to cause the processor to derive propagation properties of coherent noise using first seismic data that had been acquired in a base seismic survey. The instructions may be configured to cause the processor to derive a near-surface model from inversion of the propagation properties of coherent noise derived from the first seismic data. The instructions may be configured to cause the processor to build a velocity model using second seismic data that had been acquired in a repeat seismic survey and using the near-surface model derived from inversion of the propagation properties of coherent noise derived from the first seismic data.

The above referenced summary section is provided to introduce a selection of concepts in a simplified form that is further described in the detailed description section herein below. The summary is not intended to limit the scope of the claimed subject matter. The claimed subject matter is not limited to implementations that solve any disadvantages noted in any part of this disclosure.

### BRIEF DESCRIPTION OF THE DRAWINGS

Implementations of various techniques are hereafter described with reference to the accompanying drawings. It should be understood, however, that the accompanying drawings illustrate various implementations described herein and are not meant to limit the scope of various techniques described herein.

FIGS. 1-4 illustrate block diagrams of various methods for processing seismic data in accordance with various implementations described herein.

FIG. 5 illustrates a block diagram of a computing system in accordance with various implementations described herein.

### DETAILED DESCRIPTION

The discussion below is directed to certain specific implementations. It is to be understood that the discussion below is for the purpose of enabling a person with ordinary skill in the art to make and use any subject matter defined now or later by the patent “claims” found in any issued patent herein.

It is specifically intended that the disclosure not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It will also be understood that, although the terms first, second, etc. may be used herein to describe various elements, these elements should not be limited by these terms. These terms are used to distinguish one element from another. For example, a first object could be termed a second object, and, similarly, a second object could be termed a first object. The first object, and the second object, are both, respectively, but they are not to be considered a same object.

In various implementations, the one or more seismic sensors may include one or more geophones, hydrophones, inclinometers, particle displacement sensors, optical sensors, particle velocity sensors, accelerometers, pressure gradient sensors, or some combination thereof. Further, the one or more seismic sensors may be implemented as a single device or as a plurality of devices. A particular seismic sensor may also include pressure gradient sensors, which may constitute a type of particle motion sensor. Each pressure gradient sensor may be configured to measure changes in pressure wavefields at a particular point with respect to a particular direction. For instance, at least one of the pressure gradient sensors may acquire seismic data indicative of, at a particular point, the partial derivative of the pressure wavefield with respect to the crossline direction, and another one of the pressure gradient sensors may acquire, at a particular point, seismic data indicative of the pressure data with respect to the inline direction.

Various implementations described herein are directed to processing seismic data including using prior information for surface wave attenuation and imaging of body waves. In one implementation, a velocity model of recorded surface and guided waves from one survey may be used to improve imaging of other seismic datasets from a same or similar area. In some instances, this technique may be used to extend the method to four dimensions (4D) but gaining on use of prior information, which may be not available for other surveys. Once generated (or derived or obtained), a velocity model may be used for modeling surface and guided waves for future sparse datasets (e.g., nodal acquisition), for modeling datasets having poor quality (e.g., contaminated by noise content), and/or for modeling legacy data with different acquisition geometry (e.g., applying new knowledge to remove noise, retrospectively). Further, a same velocity model may be used as an initial or first model for near-surface perturbation corrections in reference to converted P-to-S waves (pressure-to-shear waves) and P/S-wave near-surface imaging.

One benefit to using prior information (e.g., prior seismic data) is in reduction of spatial sampling for repeat surveys that may allow for faster and more economical field acquisition. Further, using prior information may allow for suppressing of surface and guided waves in seismic datasets.

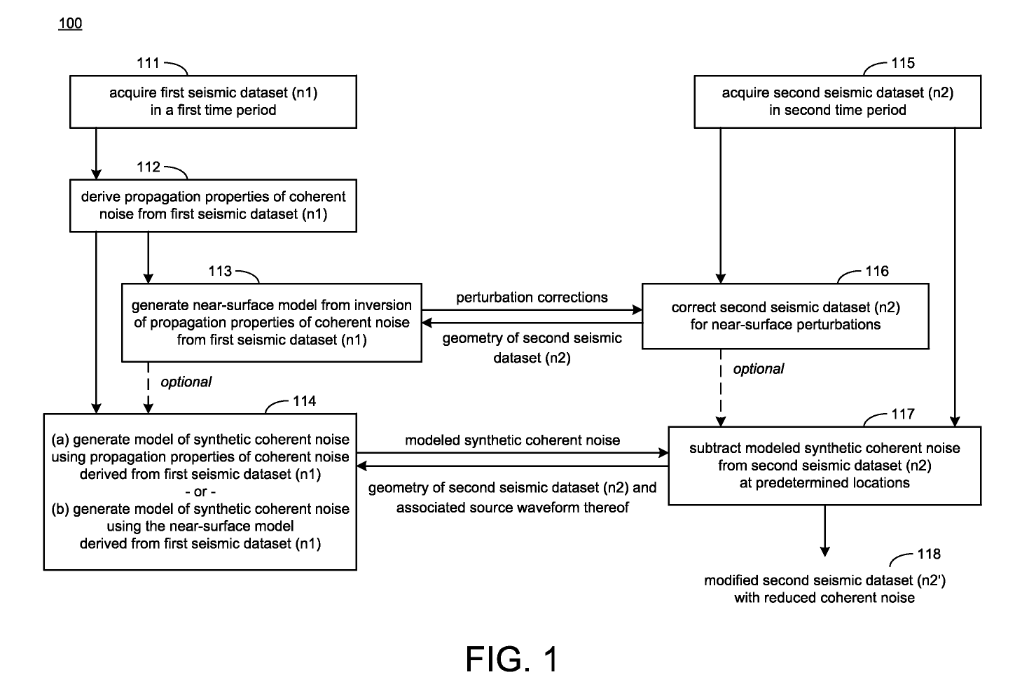

FIG. 1 illustrates a block diagram for seismic data processing in according to various implementations described herein. In block 111, method 100 may acquire a first seismic dataset (n1) over an area in a first time period (e.g., in the time and space domain). In some implementations, the first seismic dataset (n1) may have been acquired in a base seismic survey, e.g., with one or more first seismic sensors. In block 115, method 100 may acquire a second seismic dataset (n2) over the area (e.g., same or similar area) in a second time period (e.g., in the time and space domain). In some implementations, the second seismic dataset (n2) may have been acquired in a repeat seismic survey, e.g., with one or more second seismic sensors, which may be the same or different than the first seismic sensors. In this instance, the second time period is different than the first time period. As such, the first seismic dataset (n1) and the second seismic dataset (n2) may be acquired in different time periods over a same or similar area (or region). Generally, insignificant time-lapse changes in the near-surface may not deteriorate the repeatability of surface waves. However, some non-repeatability may be accommodated by adaptive subtraction, which is described in further detail herein below.

In some implementations, the first seismic data (or dataset) may include dense seismic data (or dataset) that is acquired as part of a dense survey, and the second seismic data (or dataset) may include a sparse seismic data (or dataset) that is acquired as part of a sparse survey. As will be explained herein, information from the first seismic data (or dataset) may be used to process the second seismic data (or dataset) for one or more of the following various reasons. The second seismic data (or dataset) may be sparser for economic reasons (e.g., acquisition of a dense survey may be more expensive than acquisition of sparse surveys). The second seismic data (or dataset) may not be ideal in terms of acquisition geometry (e.g., a sparse survey may be deficient in reference to acquisition geometry). The second seismic data (or dataset) may have frequency content that may not be ideal for near-surface characterization (e.g., a sparse survey may include content related to frequency that may inhibit near-surface characterization). The second seismic data (or dataset) may be contaminated by noise or strong noise (e.g., rig noise, cultural noise, environmental noise, etc.). Thus, due to characteristics of sparse surveys, the second seismic dataset may not be optimal or at least less appropriate for coherent noise (surface/guided waves) attenuation or near-surface characterization. Even if the first seismic dataset and the second seismic dataset were equivalent, time and resources may be saved using information already extracted from the first seismic dataset.

In block 112, method 100 may derive (or obtain) propagation properties of coherent noise from the first seismic dataset (n1). The properties of the coherent noise may be in a three-dimensional (3D) volume in x-y and frequency domain. Further, an output from block 112 may be referred to as a dense velocity model. In some implementations, deriving (or obtaining) propagation properties of coherent noise from the first seismic dataset (n1) may be achieved using various techniques described in commonly assigned U.S. Pat. No. 8,509,027, which is incorporated herein by reference in its entirety.

In block 114(a), method 100 may generate (or obtain or derive) a model of synthetic coherent noise using the propagation properties of coherent noise that was derived from the first seismic dataset (n1) in block 112. In some instances, the synthetic coherent noise may be modeled in the time and space domain. The model generated at block 114(a) may be performed using a computer. In some implementations, modeling coherent noise and properties of coherent noise may be derived (or obtained) using various techniques described in commonly assigned U.S. Pat. No. 7,917,295, which is incorporated herein by reference in its entirety.

As used herein, propagation properties may refer to wave types, frequency ranges, velocity ranges, phase and group velocities, and/or estimated attenuation. The propagation properties may be used for such purposes as near surface modeling, static corrections, coherent noise identification, and for purposes of producing synthetic noise for filtering procedures or survey design.

Optionally, in block 113, method 100 may generate (or obtain or derive) a near-surface model from inversion of the propagation properties of coherent noise that was derived from the first seismic dataset (n1) in block 112. As such, deriving the near-surface model may include inverting the propagation properties of coherent noise derived from the first seismic dataset (n1). Further, in block 114(b), method 100 may generate (or obtain or derive) a model of synthetic coherent noise using the near-surface model that was derived from the first seismic dataset (n1) in block 113. In some implementations, in reference to block 114(b), deriving the propagation properties of coherent noise at block 112 may include calculating the propagation properties of coherent noise based on the near-surface model which is generated (or obtained or derived) from inversion of the first seismic dataset (n1). As such, modeling the synthetic coherent noise using the first seismic dataset (n1) may be based on using the calculated propagation properties of coherent noise. Further, the near-surface model may be generated in the x-y-z domain.

Optionally, in block 116, method 100 may use the near-surface model to correct the second seismic dataset (n2) for near-surface perturbations including one or more of amplitude and phase distortions. As shown in FIG. 1, data and/or information, e.g., near-surface model, associated with perturbation corrections may be exchanged or passed from block 113 to block 116 for correcting the second seismic dataset (n2) for near-surface perturbations. Still further, as shown in FIG. 1, geometry data and/or information may be exchanged or passed from block 116 to block 113 to assist with generating (or obtaining or deriving) the near-surface model from inversion of the propagation properties of coherent noise. Further, optionally, the corrected seismic dataset (n2) may be passed to block 117.

In block 117, method 100 may modify (or adjust) the second seismic dataset (n2) using the modeled synthetic coherent noise to provide a modified second seismic dataset (n2′) with reduced coherent noise. In some implementations, modifying (or adjusting) the second seismic dataset (n2) may include subtracting the modeled synthetic coherent noise from the second seismic dataset to thereby provide the modified second seismic dataset (n2′) with reduced coherent noise. Further, modeling data and/or information associated with the modeled synthetic coherent noise may be exchanged or passed from block 114 to block 117 for modifying (or adjusting) the second seismic dataset (n2). Still further, as shown in FIG. 1, geometry data and/or information associated with the second seismic dataset (n2) and an associated source waveform thereof may be exchanged or passed from block 117 to block 114 to assist with modeling the synthetic coherent noise. Further, optionally, at block 117, method 100 may receive the corrected seismic dataset (n2) from block 116, and method 100 may modify (or adjust) the corrected second seismic dataset (n2) using the modeled synthetic coherent noise.

In block 118, method 100 provides the modified second seismic dataset (n2′) with reduced coherent noise as a resulting output. In some implementations, the resulting output refers to the second seismic data (n2) that had been acquired using the sparse survey and that has been modified/adjusted as the modified second seismic data (n2′) for near surface perturbations and attenuated from near-surface noise (e.g., based on using the synthetic coherent noise for modification and/or adjustment).

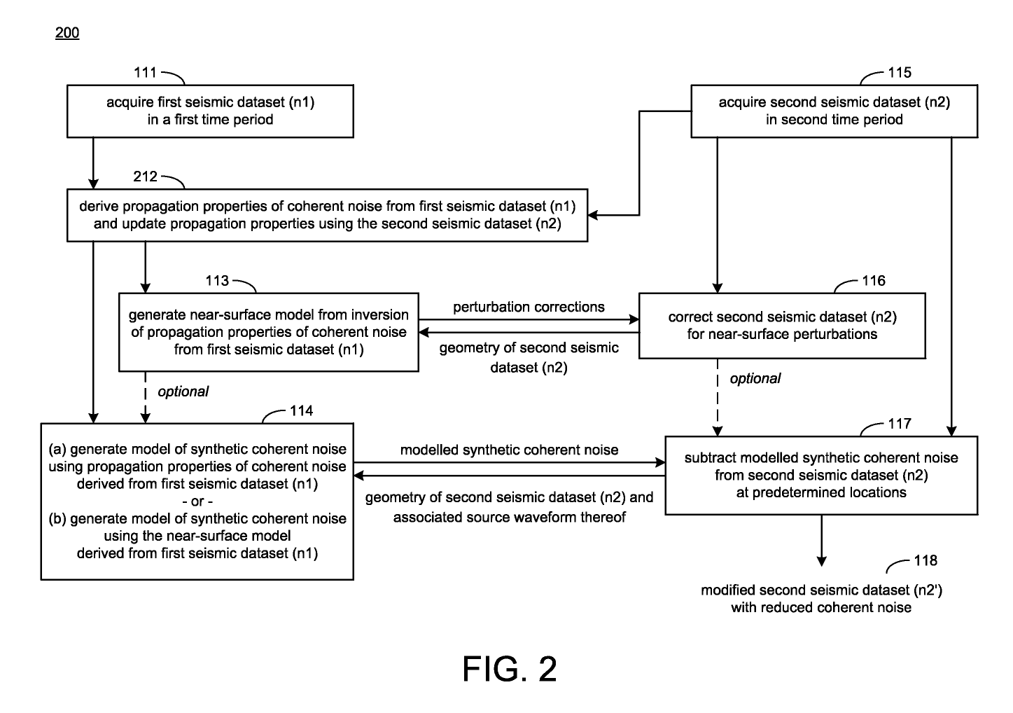

In reference to FIG. 2, similar blocks of method 200 refer to similar processing as described in reference to method 100 of FIG. 1. However, in reference to block 212, method 200 may update the first seismic dataset (n1) using the second seismic dataset (n2) along with deriving the propagation properties of coherent noise from the first seismic dataset (n1). Generally, the first seismic dataset (n1) and the second seismic dataset (n2) may be acquired in different periods over a same or similar area. Since time-lapse changes in the near-surface may deteriorate the repeatability of surface waves, the second seismic dataset (n2) may bring some additional knowledge of the near-surface. Further, some non-repeatability may be accommodated by adaptive subtraction, e.g., in a manner as described with reference to block 117. Further, in reference to block 114(a), the synthetic coherent noise model may be generated (or derived or obtained) using the updated first seismic dataset (n1), which was updated using the second seismic dataset (n2) in block 212, as previously described.

In some implementations, in reference to block 212, the propagation properties of coherent noise may be generated (or derived or obtained) from the updated first seismic dataset. In block 113, the near-surface model may be generated (or derived or obtained) from inversion of the propagation properties of coherent noise, which was generated using the updated first seismic dataset. In block 116, the second seismic dataset (n2) may be corrected for near-surface perturbations using the near-surface model, which was generated using the updated first seismic dataset. Further, in reference to block 114(b), the synthetic coherent noise model may be generated (or derived or obtained) using the near-surface model, which was generated using the updated first seismic dataset (n1).

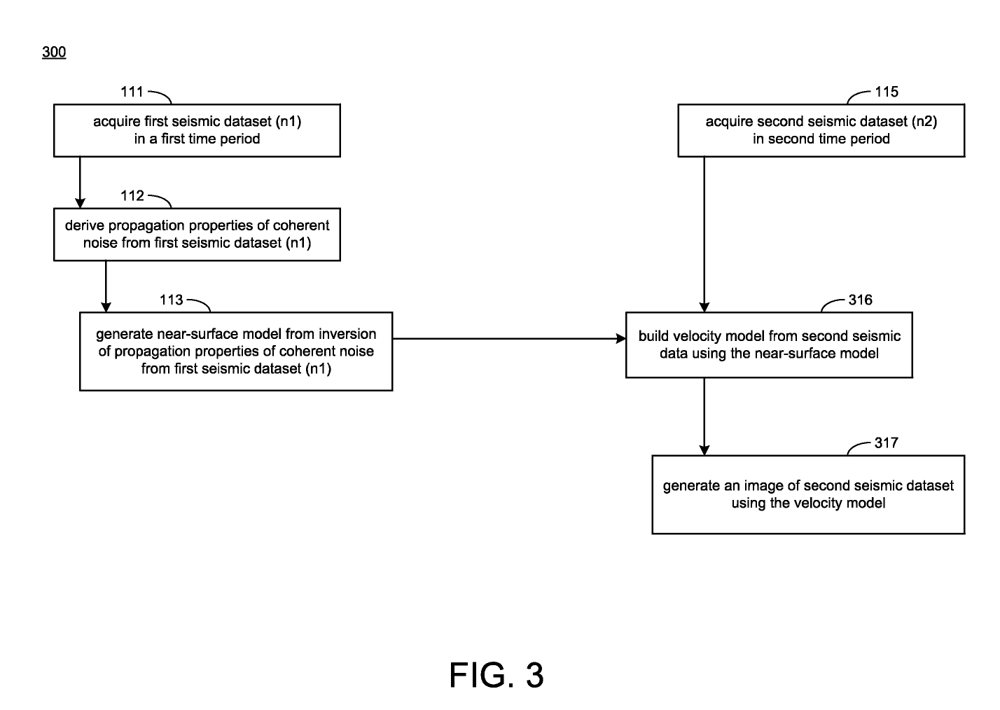

In reference to FIG. 3, similar blocks of method 300 refer to similar processing as described in reference to method 100 of FIG. 1. However, in some implementations, in reference to block 316, method 300 builds a velocity model from the second seismic data (n2) using the near-surface model as derived in block 113 from inversion of the propagation properties of coherent noise from the first seismic data (n1). Further, in block 317, method 300 generates and image of the second seismic dataset (n2) using the velocity model as provided from block 316.

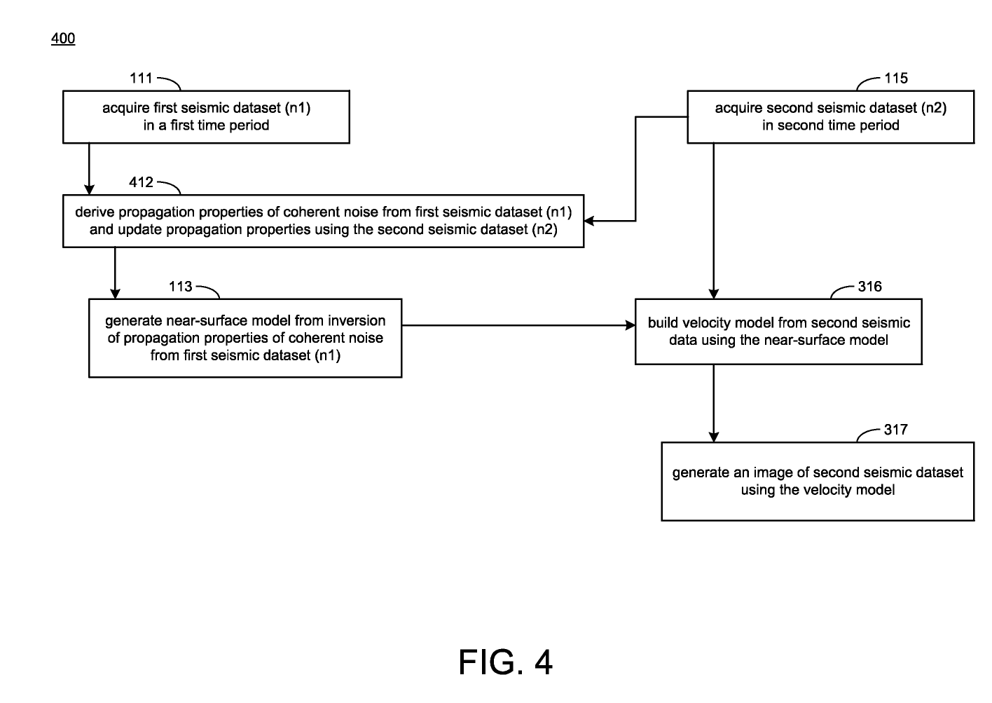

In reference to FIG. 4, similar blocks of method 400 refer to similar processing as described in reference to method 300 of FIG. 3. However, in some implementations, in reference to block 412, method 400 may update the first seismic dataset (n1) using the second seismic dataset (n2) along with deriving the propagation properties of coherent noise from the first seismic dataset (n1). Generally, time-lapse changes in the near-surface model may deteriorate the repeatability of surface waves; however, the second seismic dataset (n2) may bring some additional knowledge of the near-surface.

### Computing Systems

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smartphones, smartwatches, personal wearable computing systems networked with other computing systems, tablet computers, and distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. The distributed computing environments may span multiple continents and multiple vessels, ships or boats. In a distributed computing environment, program modules may be located in both local and remote computer storage media including memory storage devices.

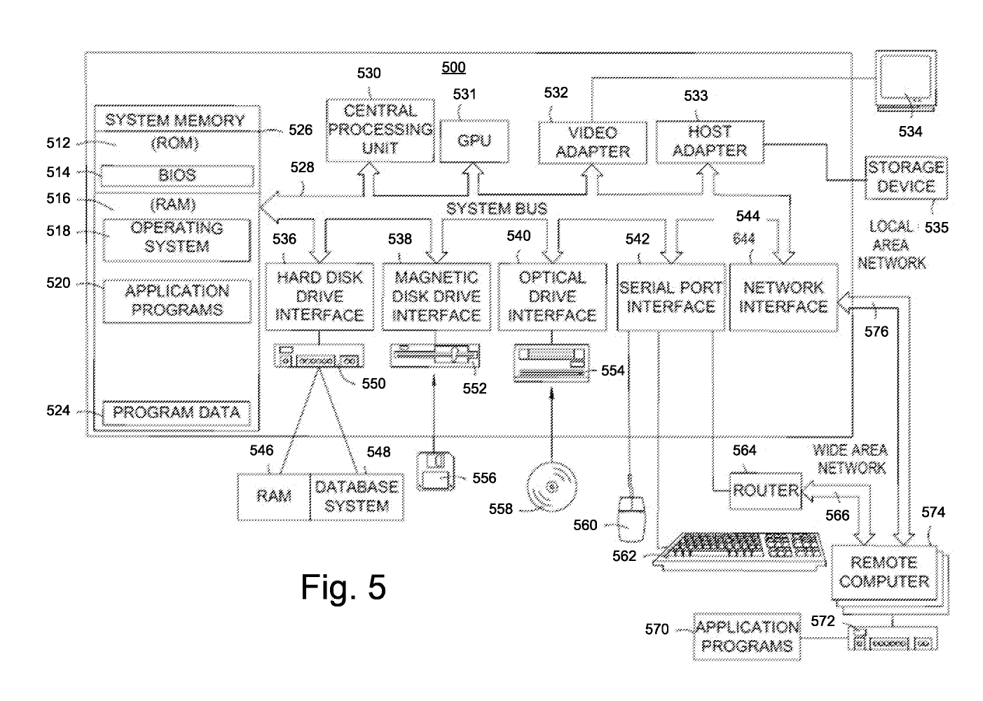

FIG. 5 illustrates a schematic diagram of a computing system 500 in which the various technologies described herein may be incorporated and practiced. Although the computing system 500 may be a conventional desktop or a server computer, as described above, other computer system configurations may be used.

The computing system 500 may include a central processing unit (CPU) 530, a system memory 526, a graphics processing unit (GPU) 531 and a system bus 528 that couples various system components including the system memory 526 to the CPU 530. Although one CPU is illustrated in FIG. 5, it should be understood that in some implementations the computing system 500 may include more than one CPU. The GPU 531 may be a microprocessor specifically designed to manipulate and implement computer graphics. The CPU 530 may offload work to the GPU 531. The GPU 531 may have its own graphics memory, and/or may have access to a portion of the system memory 526. As with the CPU 530, the GPU 531 may include one or more processing units, and the processing units may include one or more cores. The system bus 528 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 526 may include a read-only memory (ROM) 512 and a random access memory (RAM) 546. A basic input/output system (BIOS) 514, containing the basic routines that help transfer information between elements within the computing system 500, such as during start-up, may be stored in the ROM 512.

The computing system 500 may further include a hard disk drive 550 for reading from and writing to a hard disk, a magnetic disk drive 552 for reading from and writing to a removable magnetic disk 556, and an optical disk drive 554 for reading from and writing to a removable optical disk 558, such as a CD ROM or other optical media. The hard disk drive 550, the magnetic disk drive 552, and the optical disk drive 554 may be connected to the system bus 528 by a hard disk drive interface 556, a magnetic disk drive interface 558, and an optical drive interface 550, respectively. The drives and their associated computer-readable media may provide nonvolatile storage of computer-readable instructions, data structures, program modules and other data for the computing system 500.

Although the computing system 500 is described herein as having a hard disk, a removable magnetic disk 556 and a removable optical disk 558, it should be appreciated by those skilled in the art that the computing system 500 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 500. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR), and other wireless media. The computing system 500 may also include a host adapter 533 that connects to a storage device 535 via a small computer system interface (SCSI) bus, a Fiber Channel bus, an eSATA bus, or using any other applicable computer bus interface. Combinations of any of the above may also be included within the scope of computer readable media.

A number of program modules may be stored on the hard disk 550, magnetic disk 556, optical disk 558, ROM 512 or RAM 516, including an operating system 518, one or more application programs 520, program data 524, and a database system 548. The application programs 520 may include various mobile applications (“apps”) and other applications configured to perform various methods and techniques described herein. The operating system 518 may be any suitable operating system that may control the operation of a networked personal or server computer, such as Windows® XP, Mac OS® X, Unix-variants (e.g., Linux® and BSD®), and the like.

A user may enter commands and information into the computing system 500 through input devices such as a keyboard 562 and pointing device 560. Other input devices may include a microphone, joystick, game pad, satellite dish, scanner, or the like. These and other input devices may be connected to the CPU 530 through a serial port interface 542 coupled to system bus 528, but may be connected by other interfaces, such as a parallel port, game port or a universal serial bus (USB). A monitor 534 or other type of display device may also be connected to system bus 528 via an interface, such as a video adapter 532. In addition to the monitor 534, the computing system 500 may further include other peripheral output devices such as speakers and printers.

Further, the computing system 500 may operate in a networked environment using logical connections to one or more remote computers 574. The logical connections may be any connection that is commonplace in offices, enterprise-wide computer networks, intranets, and the Internet, such as local area network (LAN) 556 and a wide area network (WAN) 566. The remote computers 574 may be another a computer, a server computer, a router, a network PC, a peer device or other common network node, and may include many of the elements describes above relative to the computing system 500. The remote computers 574 may also each include application programs 570 similar to that of the computer action function.

When using a LAN networking environment, the computing system 500 may be connected to the local network 576 through a network interface or adapter 544. When used in a WAN networking environment, the computing system 500 may include a router 564, wireless router or other means for establishing communication over a wide area network 566, such as the Internet. The router 564, which may be internal or external, may be connected to the system bus 528 via the serial port interface 552. In a networked environment, program modules depicted relative to the computing system 500, or portions thereof, may be stored in a remote memory storage device 572. It will be appreciated that the network connections shown are merely examples and other means of establishing a communications link between the computers may be used.

The network interface 544 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 574.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, on the user's computing device, as a stand-alone software package, on the user's computer and on a remote computer or entirely on the remote computer or a server computer.

The system computer 500 may be located at a data center remote from the survey region. The system computer 500 may be in communication with the receivers (either directly or via a recording unit, not shown), to receive signals indicative of the reflected seismic energy. These signals, after conventional formatting and other initial processing, may be stored by the system computer 500 as digital data in the disk storage for subsequent retrieval and processing in the manner described above. In one implementation, these signals and data may be sent to the system computer 500 directly from sensors, such as geophones, hydrophones and the like. When receiving data directly from the sensors, the system computer 500 may be described as part of an in-field data processing system. In another implementation, the system computer 500 may process seismic data already stored in the disk storage. When processing data stored in the disk storage, the system computer 500 may be described as part of a remote data processing center, separate from data acquisition. The system computer 500 may be configured to process data as part of the in-field data processing system, the remote data processing system or a combination thereof.

Those with skill in the art will appreciate that any of the listed architectures, features or standards discussed above with respect to the example computing system 500 may be omitted for use with a computing system used in accordance with the various embodiments disclosed herein because technology and standards continue to evolve over time.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a three-dimensional space and/or subsurface region of interest may be collected and processed, e.g., medical imaging techniques such as tomography, ultrasound, MRI and the like for human tissue; radar, sonar, and LIDAR imaging techniques; and other appropriate three-dimensional imaging problems.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims should not be limited to the specific features or acts described above. Rather, the specific features and acts described above are disclosed as example forms of implementing the claims.

What is claimed is:

1. A method for processing seismic data, comprising:
generating a computer-generated synthetic coherent noise model using a first seismic dataset that had been acquired with seismic sensors in a base seismic survey; and
modifying a second seismic dataset that had been acquired in a repeat seismic survey using the computer-generated synthetic coherent noise model to generate a modified second seismic dataset having reduced coherent noise.

2. The method of claim 1, wherein the first and second seismic datasets comprise seismic data related to one or more of surface waves and guided waves.

3. The method of claim 1, further comprising deriving propagation properties of coherent noise from the first seismic dataset, and generating the computer-generated synthetic coherent noise model using the derived propagation properties of coherent noise.

4. The method of claim 3, wherein deriving the propagation properties of coherent noise from the first seismic dataset comprises updating the first seismic dataset using the second seismic dataset.

5. The method of claim 3, further comprising:
inverting the propagation properties of coherent noise derived from the first seismic dataset, and
deriving a near-surface model from inversion of the propagation properties of coherent noise from the first seismic dataset.

6. The method of claim 5, wherein deriving the propagation properties of coherent noise comprises calculating the propagation properties of coherent noise based on the near-surface model which is derived from inversion of the first seismic dataset, and wherein the computer generated synthetic coherent noise model is generated using the calculated propagation properties of coherent noise.

7. The method of claim 1, further comprising:
updating the first seismic dataset using the second seismic dataset;
deriving propagation properties of coherent noise from the updated first seismic dataset;
inverting the propagation properties of coherent noise derived from the updated first seismic dataset;
deriving a near-surface model from inversion of the propagation properties of coherent noise from the updated first seismic dataset; and
using the near-surface model to correct the second seismic dataset for near-surface perturbations.

8. The method of claim 7, wherein the near-surface perturbations comprise one or more of amplitude and phase distortions.

9. The method of claim 1, further comprising:
updating the first seismic dataset using the second seismic dataset, and
generating the computer-generated synthetic coherent noise model using the updated first seismic dataset.

10. The method of claim 1, wherein the first seismic dataset comprises a dense seismic dataset that had been acquired as part of a dense survey, and wherein the second seismic dataset comprises a sparse seismic dataset that had been acquired as part of a sparse survey, and wherein the second seismic dataset is contaminated by noise including one or more of rig noise, cultural noise, and environmental noise.

11. The method of claim 1, wherein modifying the second seismic dataset comprises subtracting the computer generated synthetic coherent noise model from the second seismic dataset to generate the modified second seismic dataset having reduced coherent noise.

12. A non-transitory computer-readable medium having stored thereon a plurality of computer-executable instructions which, when executed by a computer, cause the computer to:
generate a computer-generated synthetic coherent noise model using a first seismic dataset that had been acquired with seismic sensors in a base seismic survey, and
modify a second seismic dataset that had been acquired in a repeat seismic survey using the computer-generated synthetic coherent noise model to generate a modified second seismic dataset having reduced coherent noise.

13. The computer-readable medium of claim 12, wherein the first seismic dataset comprises a dense seismic dataset that had been acquired as part of a dense survey, and wherein the second seismic dataset comprises a sparse seismic dataset that had been acquired as part of a sparse survey.

14. The computer-readable medium of claim 12, wherein the second seismic dataset had been contaminated by noise including one or more of rig noise, cultural noise, and environmental noise.

15. The computer-readable medium of claim 12, wherein the instructions further include instructions that cause the computer to:
derive propagation properties of coherent noise from the first seismic dataset;
update the first seismic dataset using the second seismic dataset; and
use the near-surface model to correct the second seismic dataset for near-surface perturbations.

16. The computer-readable medium of claim 12, wherein the instructions for modifying the second seismic dataset further include instructions for subtracting the synthetic coherent noise from the second seismic dataset to generate the modified second seismic dataset having reduced coherent noise.

17. An apparatus comprising:
a processor; and
memory having instructions stored thereon that, when executed by the processor, cause the processor to:
derive propagation properties of coherent noise using first seismic data that had been acquired in a base seismic survey,
derive a near-surface model from inversion of the propagation properties of coherent noise derived from the first seismic data, and
build a velocity model using second seismic data that had been acquired in a repeat seismic survey and using the near-surface model derived from inversion of the propagation properties of coherent noise derived from the first seismic data.

18. The apparatus of claim 17, wherein the first seismic data comprises dense seismic data that had been acquired as part of a dense survey, and wherein the second seismic data comprises sparse seismic data that had been acquired as part of a sparse survey,

19. The apparatus of claim 17, wherein the instructions for deriving the propagation properties of coherent noise using the first seismic data include instructions for updating the first seismic data using the second seismic data.

20. The apparatus of claim 17, wherein the memory further include instructions that cause the computer to:
generate an image of the second seismic dataset using the velocity model.
